(19) United States
(12) Patent Application Publication
(10) Pub. No.: US 2006/0136619 A1
(43) Pub. Date: Jun. 22, 2006

(54) Data integrity processing and protection techniques

(75) Inventors: Samantha Edirisooriya, Tempe, AZ (US); Gregory Tse, Tempe, AZ (US); Joseph Murray, Scottsdale, AZ (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/017,183

(22) Filed: Dec. 16, 2004

(51) Int. Cl. G06F 5/00

(52) U.S. Cl. 710/52

(57) ABSTRACT

Techniques to accelerate block guard processing of data by use of block guard units in a path between a source memory device and an originator of a data transfer request. The block guard unit may intercept the data transfer request and data transferred in response to the data transfer request. The block guard unit may utilize a cache to store information useful to verify block guards associated with the data.

### FIELD

The subject matter disclosed herein relates to techniques to transfer data.

### RELATED ART

T10 is a Technical Committee of the InterNational Committee for Information Technology Standards (INCITS). INCITS develops standards relating to information processing systems. The T10 committee (SCSI) document T10/03-365 revision 1 (2003) which describes SPC-3, SBC-2, and End-to-End Data Protection describes the use of block guards. Block guards may be appended to blocks of data for use in verifying the integrity of data transmitted between two nodes. Typically a block guard has three components: (1) a tag that identifies a logical I/O operation; (2) a tag that identifies which block within the logical I/O the block is associated with; and (3) two bytes cyclical redundancy check (CRC) computed over the data.

### BRIEF DESCRIPTION OF THE DRAWINGS

FIG. 1 depicts a suitable system in which embodiments of the present invention may be used.

FIG. 2 depicts an example implementation of an input/output system that can be used at least for transfer of information between memory devices.

FIG. 3 depicts an example format of a context, in accordance with an embodiment of the present invention.

FIG. 4 depicts an example implementation of a block guard unit in accordance with an embodiment of the present invention.

FIG. 5 depicts an example implementation of a context cache in accordance with an embodiment of the present invention.

FIGS. 6A to 6C depict example flow diagrams that can be used in accordance with an embodiment of the present invention.

FIG. 7 depicts an example of data shifting and block guard appending in accordance with an embodiment of the present invention.

Note that use of the same reference numbers in different figures indicates the same or like elements.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

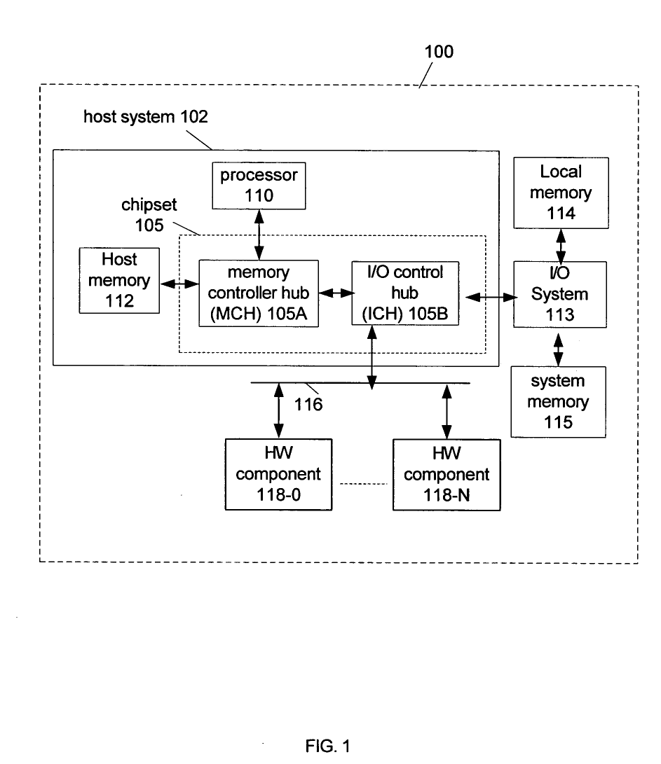

FIG. 1 depicts in computer system 100 a suitable system in which embodiments of the present invention may be used. Computer system 100 may include host system 102, I/O system 113, local memory 114, system memory 115, bus 116, and hardware (HW) components 118-0 to 118-N.

Host system 102 may include chipset 105, processor 110, and host memory 112. Chipset 105 may include a memory controller hub (MCH) 105A that may provide intercommunication among processor 110 and host memory 112 as well as a graphics adapter that can be used for transmission of graphics and information for display on a display device (both not depicted). Chipset 105 may further include an I/O control hub (ICH) 105B that may provide intercommunication among MCH 105A, I/O system 113, and bus 116. In one embodiment, I/O system 113 may intercommunicate with MCH 105A instead of ICH 105B.

Processor 110 may be implemented as Complex Instruction Set Computer (CISC) or Reduced Instruction Set Computer (RISC) processors, multi-core, or any other microprocessor or central processing unit. Host memory 112 may be implemented as a volatile memory device (e.g., Random Access Memory (RAM), Dynamic Random Access Memory (DRAM), or Static RAM (SRAM)).

In accordance with an embodiment of the present invention, I/O system 113 may provide direct memory access (DMA) operations (e.g., write or read) for transfers of information between host memory 112 and local memory 114, although non-DMA access operations may be supported. I/O system 113 may provide block guard verification, replacement, and/or appending for transfers of data between host memory 112 and local memory 114. A block guard may have the format described earlier or may utilize a different format. For example, a PCI or PCI express compatible interface may be used to provide intercommunication between I/O system 113 and chipset 105.

Local memory 114 may be implemented as a volatile memory device (e.g., Random Access Memory (RAM), Dynamic Random Access Memory (DRAM), or Static RAM (SRAM)). System memory 115 may be implemented as a non-volatile storage device such as a magnetic disk drive, optical disk drive, tape drive, an internal storage device, an attached storage device, and/or a network accessible storage device. For example, system memory 115 may intercommunicate with I/O system 113 using any of the following standards: Serial Attached SCSI (SAS) described for example in Serial Attached SCSI specification 1.0 (November 2003); serial ATA described for example at “Serial ATA: High Speed Serialized AT Attachment,” Revision 1.0, published on Aug. 29, 2001 by the Serial ATA Working Group (as well as related standards) (SATA); small computer system interface (SCSI) described for example in American National Standards Institute (ANSI) Small Computer Systems Interface-2 (SCSI-2) ANSI X3.131-1994 Specification; and/or Fibrechannel described for example in ANSI Standard Fibre Channel (FC) Physical and Signaling Interface-3 X3.303:1998 Specification; although other standards may be used. Routines and information stored in system memory 115 may be loaded into host memory 112 and executed by processor 110. For example, system memory 115 may store an operating system as well as applications used by system 100.

Bus 116 may provide intercommunication among host system 102, I/O system 113, and HW components 118-0 to 118-N. Bus 116 may support node-to-node or node-to-multi-node communications. Bus 116 may be compatible with Peripheral Component Interconnect (PCI) described for example at Peripheral Component Interconnect (PCI) Local Bus Specification, Revision 2.2, Dec. 18, 1998 available from the PCI Special Interest Group, Portland, Oreg., U.S.A. (as well as revisions thereof); PCI Express described in The PCI Express Base Specification of the PCI Special Interest Group, Revision 1.0a (as well as revisions thereof); PCI-x described in the PCI-X Specification Rev. 1.0a, Jul. 24, 2000, available from the aforesaid PCI Special Interest Group, Portland, Oreg., U.S.A. (as well as revisions thereof); SATA; and/or Universal Serial Bus (USB) (and related standards) as well as other interconnection standards.

Each of HW components 118-0 to 118-N may be any device capable of receiving information from host system 102 or providing information to host system 102. HW components 118-0 to 118-N can be integrated into the same computer platform as that of host system 102. HW components 118-0 to 118-N may intercommunicate with host system 102 through bus 116. For example, any of HW components 118-0 to 118-N may be implemented as a network interface capable of providing intercommunication between host system 102 and a network in compliance with formats such as Ethernet or SONET/SDH. For example, any of HW components 118-0 to 118-N may be implemented as a bus or interface bridge such as a PCI-to-PCI express bridge or a graphics co-processing or display interface device.

Computer system 100 may be implemented as any or a combination of: microchips or integrated circuits interconnected using a motherboard, hardwired logic, software stored by a memory device and executed by a microprocessor, firmware, an application specific integrated circuit (ASIC), and/or a field programmable gate array (FPGA).

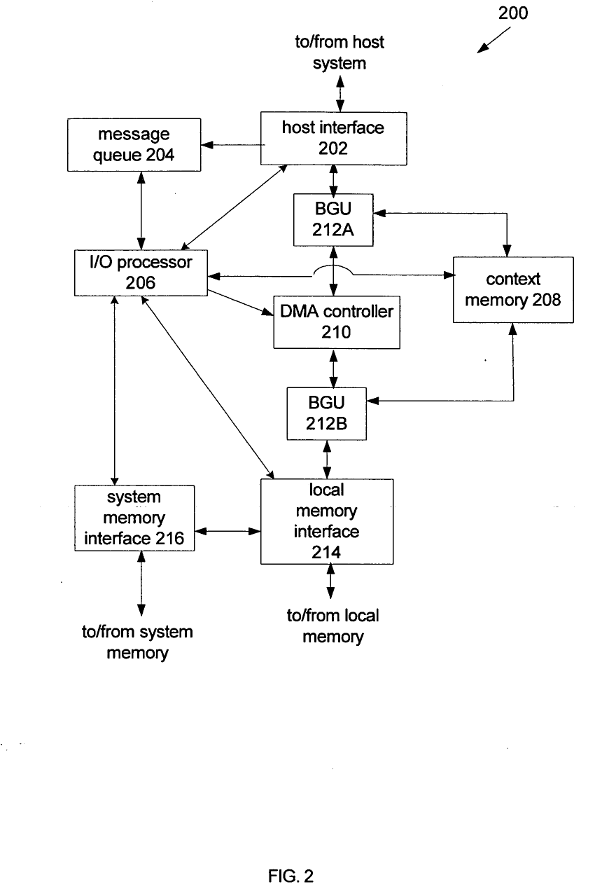

FIG. 2 depicts an example implementation of an input/output (I/O) system 200 that can be used at least for transfer of information between a host memory (such as, but not limited to, host memory 112) and a local memory (such as, but not limited to, local memory 114). I/O system 200 may be used to transfer information between any two memory devices. One implementation of I/O system 200 may include host interface 202, message queue 204, I/O processor 206, context memory 208, DMA controller 210, block guard unit (BGU) 212A and 212B, local memory interface 214, and system memory interface 216.

Host interface 202 may provide intercommunication between I/O system 200 and a host system (such as, but not limited to, host system 102). For example, when a host memory device (such as, but not limited to, host memory 112) in the host system requests data transfer between the host memory device and a local memory (such as, but not limited to, local memory 114), the host system may create a host descriptor list which may include a source address of the information to be transferred, destination address of the information to be transferred, and total size of the information to be transferred. The host system may transfer a pointer to the descriptor list to message queue 204 through host interface 202. A descriptor list may include a request to transfer multiple blocks as well as portions of blocks. For example, a block may be 512 bytes in size, although other sizes may be used.

Message queue 204 may store pointers to host descriptor lists stored in the host system. For example, message queue 204 may generate an interrupt of I/O processor 206 to request I/O processor 206 to retrieve a pointer or I/O processor 206 may poll the message queue 204 for availability of pointers to the host descriptor list.

I/O processor 206 may request that each host descriptor list associated with a pointer retrieved from message queue 204 be transferred to I/O system 200. For example, the transferred host descriptor list may be stored into local memory. In one embodiment, I/O processor 206 may request that DMA controller 210 retrieve the descriptor list from host memory and store the descriptor list into local memory. I/O processor 206 may create contexts based in part on each host descriptor list and store each context into context memory 208. A block guard unit (such as BGU 212A or 212B) may derive a block guard from a context by extracting contents of context as well as from the data moved through block guard unit 212A or 212B.

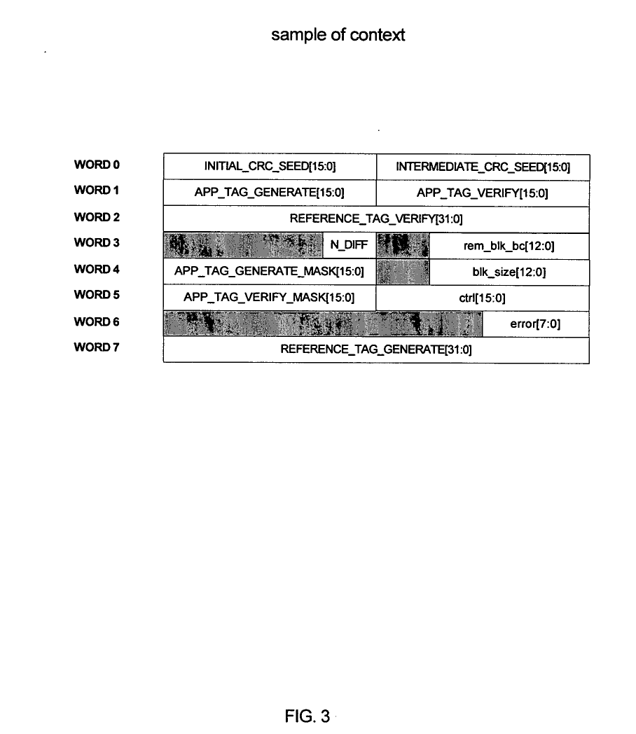

For example, FIG. 3 depicts an example format of a context, in accordance with an embodiment of the present invention, although other information may be conveyed in a context. The example context may include eight rows of 32 bytes in length, however other sizes may be used. For example, a context may include the fields with possible descriptions provided in the following table.

| FIELD NAME | BRIEF DESCRIPTION |
|---|---|
| INITIAL_CRC_SEED | Can be an initial CRC value for a |
| | stream of data blocks. |
| INTERMEDIATE_CRC_SEED | Can be temporary storage of |
| | partial CRCs associated with |
| | partial data block transfers. |
| APP_TAG_GENERATE | This field may be used to identify |
| | an entire data stream. This field |
| | may be used as the source of the |
| | Application Tag (which may be |
| | defined by the application and may |
| | be a logical I/O ID) for block |
| | guard append or replace |
| | operations. For block guard |
| | update operations, the Application |
| | Tag bits of the incoming data |
| | block may be replaced on a bit-by- |
| | bit basis as specified by the |
| | APP_TAG_GENERATE_MASK. |
| APP_TAG_GENERATE_MASK | During a block guard verify or |
| | replace operation, this field may |
| | determine on a bit-by-bit basis |
| | which bits of the APP_TAG_GENERATE |
| | field may replace bits in the |
| | Application Tag of the incoming |
| | data blocks. When a given bit in |
| | the APP_TAG_GENERATE_MASK is set, |
| | that bit from the APP_TAG_GENERATE |
| | field may be placed into the |
| | outgoing Application Tag, |
| | otherwise, the bit from the |
| | incoming Application Tag may be |
| | forwarded to the outgoing |
| | Application Tag. |
| REFERENCE_TAG_GENERATE | May identify each data block in a |
| | data stream. The BGU may generate |
| | this field for the outgoing data |
| | blocks using this field and |
| | incremented versions of this |
| | field. |
| APP_TAG_VERIFY | When verifying block guards for |
| | incoming data blocks, this value |
| | may be compared against the |
| | incoming Application Tag on a bit- |
| | by-bit basis as specified by the |
| | APP_TAG_VERIFY_MASK. |
| APP_TAG_VERIFY_MASK | During a block guard verify or |
| | replace operation, this field may |
| | be used to determine on a bit-by- |
| | bit basis which bits of the |
| | incoming data blocks' Application |
| | Tag are verified against the |
| | corresponding bits of the |
| | APP_TAG_VERIFY field. |
| REFERENCE_TAG_VERIFY | For a sequence of data transfers |
| | that represent a set of contiguous |
| | data blocks, this field may be |
| | initialized at the beginning of |
| | the data transfer in the sequence. |
| | The Reference Tag of the incoming |
| | data blocks may be verified using |
| | this field and incremented |
| | versions of this field. When |
| | current data transfer processing |
| | is concluded, the incremented |
| | version of this field to the |
| | context may be written back. |
| N_DIFF | May represent the number of data |
| | integrity fields that have been |
| | processed during block guard |
| | verify and generation operations. |
| | Can be used to adjust a |
| | destination address of data blocks |
| | after a block guard append has |
| | taken place to a previous grouping |
| | of data blocks. |
| Rem_blk_bc | May represent a remaining byte |
| | count of data in a group of data |
| | blocks that was not previously |
| | processed. |
| Blk_size | May represent a size of a data |
| | block. |
| Control (Ctrl) | Generally specifies operation for |
| | BGU to perform. |
| Error | Stores error information derived |
| | from processing block guards. |

I/O processor 206 may also create a DMA descriptor to describe a transport request based on each host descriptor list. The DMA descriptor may include a source address of the information to be transferred, a destination address of the information to be transferred, byte count of the information to be transferred, a read or write request, as well as a pointer to an associated context. I/O processor 206 may transfer the DMA descriptor to DMA controller 210 for execution. DMA descriptors may be stored by DMA controller 210 or in local memory.

Context memory 208 may store contexts. Context memory 208 may be implemented using a local memory or other memory device such as a random access memory (RAM) device. Context memory 208 may provide contexts to a context cache of BGU 212A or BGU 212B in accordance with an embodiment of the present invention. In one embodiment, BGU 212A or BGU 212B may write updated or evicted contexts into context memory 208.

DMA controller 210 may convert each DMA descriptor into a read/write request at least with a context pointer and beginning of I/O stream indicator (hereafter “read/write requests” or individually, a “read request” or “write request”). DMA controller 210 may transfer the read/write requests to initiate the reading or writing of information from or into host or local memory. For example, DMA controller 210 may include a buffer to temporarily store information transferred between host memory and local memory.

BGU 212 refers to any of BGU 212A and 212B. BGU 212 may receive read/write requests transferred to host or local memory. BGU 212 may extract context pointers from each read/write request. In one embodiment, BGU 212 may include a context cache. BGU 212 may attempt to retrieve a context associated with each context pointer from the context cache. If the context cache stores the context, then the BGU 212 may utilize the context from the context cache to determine a block guard associated with the data. If the context cache does not store the context, then the BGU 212 may request the context from context memory 208 and thereafter the BGU may process the received data using the requested context.

BGU 212 may receive data from a source (e.g., host memory or local memory) provided in response to a read request received by the source device. The data may include an appended block guard. For example, for data received in response to a read or write request, BGU 212 may (1) verify the block guard; (2) verify the block guard and replace block guard; or (3) verify the block guard and append another block guard. After a block guard verification, replacement, and/or appending, the data may be transferred to the destination device such as DMA controller 210 or host or local memory.

Local memory interface 214 may provide intercommunication between I/O system 200 and a local memory. For example, local memory interface 214 may be implemented as an SDRAM interface (e.g., DDR or DDR2), SRAM interface, or other type of interface depending on the type of local memory used.

System memory interface 216 may provide intercommunication between I/O system 200 and a system memory. For example, system memory interface 216 may comply with any of the following standards: SAS, SATA, SCSI, and/or Fibrechannel, although other standards may be used.

For example, the following provides an example of data transfer from the host memory to a local memory. When reversed, the example may apply to data transfer from local memory to host memory. (a) a DMA controller issues a read request to host memory; (b) BGU 212A receives the read request and extracts the context pointer from the read request and determines whether the context is in a context cache of BGU 212A; (c) BGU 212A receives the data transferred by the host memory in response to the read request; (d) BGU 212A verifies, replaces, and/or appends a block guard associated with the data; (e) the data with block guard processed in (d) is stored into a buffer in the DMA controller; (f) the DMA controller issues a write request to the local memory requesting a data write operation; (g) BGU 212B receives the write request and extracts the context pointer from the write request and determines whether the context is in a context cache of BGU 212B; (h) the data (and block guard, as the case may be) stored in (e) may be transferred to the local memory; (i) the BGU 212B intercepts the data transferred to the local memory and verifies, replaces, and/or appends a block guard associated with such data; and (j) BGU 212B transfers the data with the block guard processed in (i) into local memory. In another example, only BGU 212A or BGU 212B processes the block guard and not both.

I/O system 200 may be implemented as any or a combination of: microchips interconnected using a motherboard, hardwired logic, software stored by a memory device and executed by a microprocessor, firmware, an application specific integrated circuit (ASIC), and/or a field programmable gate array (FPGA).

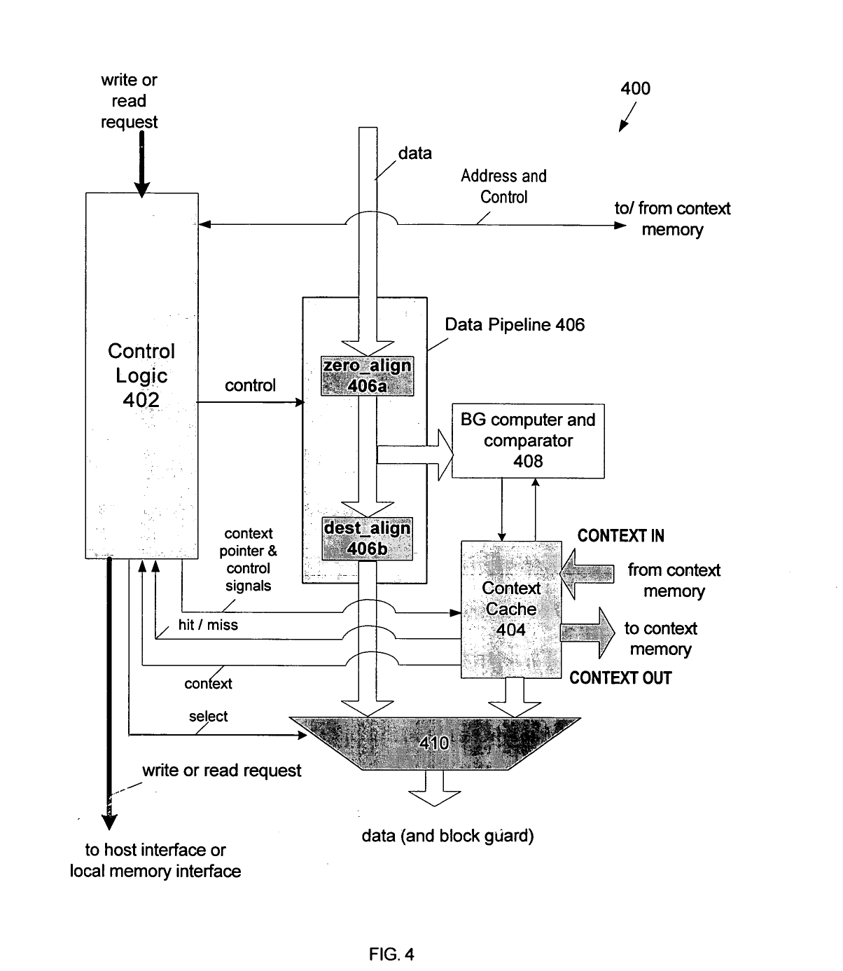

FIG. 4 depicts an example implementation of a block guard unit (BGU) 400 in accordance with an embodiment of the present invention. For example, block guard unit 400 may include control logic 402, context cache 404, data pipeline 406, block guard (BG) computer and comparator 408, and multiplexer 410. In one embodiment, BGU 400 may be transparent to the DMA controller and the host or local memories but may intercept requests and data transferred between DMA controller and host memory as well as between DMA controller and local memory.

Control logic 402 may read the read/write request transferred by DMA controller to host or local memory. For example, control logic 402 may extract a context pointer from each read/write request. Control logic 402 may examine the context pointer to determine if the associated context is stored in context cache 404. For example, control logic 402 may provide the context pointer to context cache 404. If context cache 404 stores the context associated with the context pointer, context cache 404 provides an indication of a “hit”. If context cache 404 does not store the context associated with the context pointer, context cache 404 provides an indication of a “miss” and control logic 402 may request the context memory to provide the context to context cache 404 for storage. Use of context cache 404 may help block guard unit 400 speed the rate of verifying, replacing, and/or appending a block guard with data.

Control logic 402 may determine a block guard from context. In one embodiment, a block guard may be generated using the following fields from a context: (1) INITIAL_CRC_SEED or INTERMEDIATE_CRC_SEED; (2) REFERENCE_TAG_GENERATE; and (3) APP_TAG_GENERATE.

Control logic 402 may modify the destination address transmitted with a read/write request to account for the appending of a block guard to a data stream. For example, if a data stream includes more than one data block and a block guard is appended to a first data block in the data stream, the starting storage address of the remaining portion of the data stream is modified to account for the addition of the block guard.

Data pipeline 406 may intercept data provided by or to a host or local memory in response to a read/write request. For example, data pipeline 406 may be capable of transferring sixteen (16) byte-sized data lanes in parallel. For example, zero_align 406a may shift the first valid byte of the data to a zero byte lane among the data lanes so that BG computer 408 receives as many bytes at a time to process. Zero_align 406a may provide the lane shifted data stream to BG computer 408 and dest_align 406b.

If a block guard is verified or replaced, dest_align 406b may shift data into the original data lane positions provided at the input to the data pipeline 406. If a block guard is appended to the data, dest_align 406b may shift data after the appending of the block guard by the size of the block guard to account for the addition of a block guard. Dest_align 406b may provide sixteen (16) bytes of data in parallel to multiplexer 410, although other number of data lanes may be used.

BG computer and comparator 408 may receive data from data pipeline 406. BG computer and comparator 408 may inspect each data block in a data stream and for each data block, BG computer and comparator 408 may determine the CRC based on a block guard derived from a context provided in response to a context pointer associated with the data. BG computer and comparator 408 may compare the determined CRC against the CRC in the block guard provided with the data for a match/mismatch. If a mismatch occurs, BG computer and comparator 408 may indicate error and stop accepting data. If a match occurs, then the BG computer and comparator 408 may proceed. BG computer and comparator 408 may at least: (1) verify block guards associated with the received data; (2) verify block guards and replace block guards with replacement block guards; or (3) verify block guards and generate block guards for appending to the data.

For example, for (1), to verify a block guard associated with received data, BG computer 408 may compute the CRC for each data block in a data stream and then BG computer and comparator 408 may compare the computed CRC against the CRC in the block guard associated with the data. A data block may be 512 bytes in length, although other lengths may be used.

For example, for (2), to verify block guards and replace block guards associated with the received data, BG computer 408 may compute a CRC for each data block in the data stream and BG computer and comparator 408 may compare the computed CRC against the CRC in the block guard associated with the data block. For example, to replace the block guard, multiplexer 410 may be controlled to not transfer a block guard and instead replace the block guard with a replacement block guard derived from a context provided in response to a context pointer associated with the data. The replacement block guard may include the computed CRC.

For example, for (3), to verify block guards and generate block guards for appending to the data, BG computer 408 may compute a CRC for each data block in the data stream and may compare the computed CRC against the CRC in the block guard associated with the data block. For example, a computed CRC may be appended in a block guard after a 512 byte sized data block. For example, to append a block guard, multiplexer 410 may be controlled to append the block guard derived from a context provided in response to a context pointer associated with the data. The appended block guard may be derived from the context provided in response to the context pointer associated with the data to which the appended block guard is appended. The appended block guard may include the computed CRC.

To the extent the block guard unit 400 updates or modifies a block guard (e.g., by modifying the CRC), the modified block guard may be replaced in the context cache 404.

Control logic 402 may decide whether the output of multiplexer 410 is from the data pipeline 406 or from context cache 404 (or in place of context cache 404, BG computer and comparator 408). For example, a block guard to be replaced or appended may be provided by context cache 404 or BG computer and comparator 408. Accordingly, multiplexer 410 may be used to replace or append block guards by controlling whether block guards are transferred downstream.

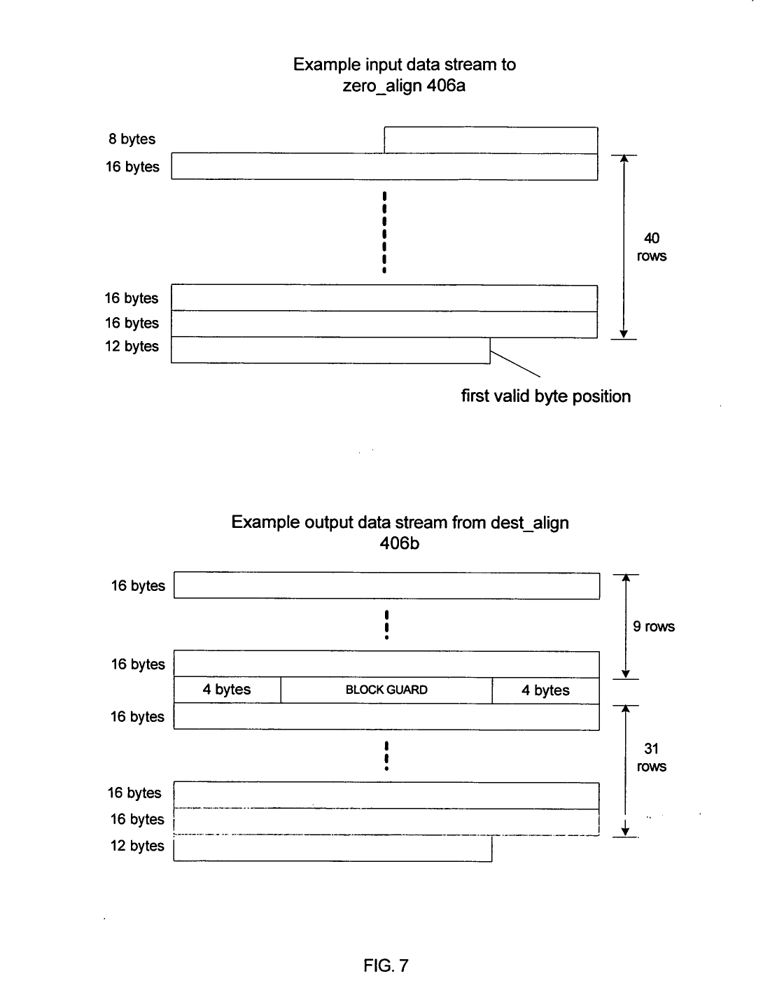

For example, FIG. 7 depicts an example of data transfer and block guard appending in accordance with an embodiment of the present invention. For example, a block size of 512 bytes may be used and the transaction involves moving 660 bytes of data. As shown, a data stream enters data pipeline 406 in parallel (16 byte-sized lanes at a time). In this example, the BGU is to add eight (8) bytes of block guard to the first data block. Accordingly, the destination address of the beginning of the remaining bytes of the 660 bytes of data will be shifted by eight (8) bytes. Accordingly, control logic 402 modifies the destination address for the remaining bytes of the 660 bytes of data transmitted with the read/write request to account for the addition of the block guard.

After a first 512 byte data block has been processed, zero_align 406a may shift the first valid byte of the remaining portion of the 660 bytes of data to the zero byte lane (e.g., right most lane). The dest_align 406b shifts the first valid byte of the remaining portion of the 660 bytes of data comes from the fourth (4^{th}) byte lane to the twelfth (12th) byte lane to account for appending of the eight (8) byte block guard to the end of the previous data block.

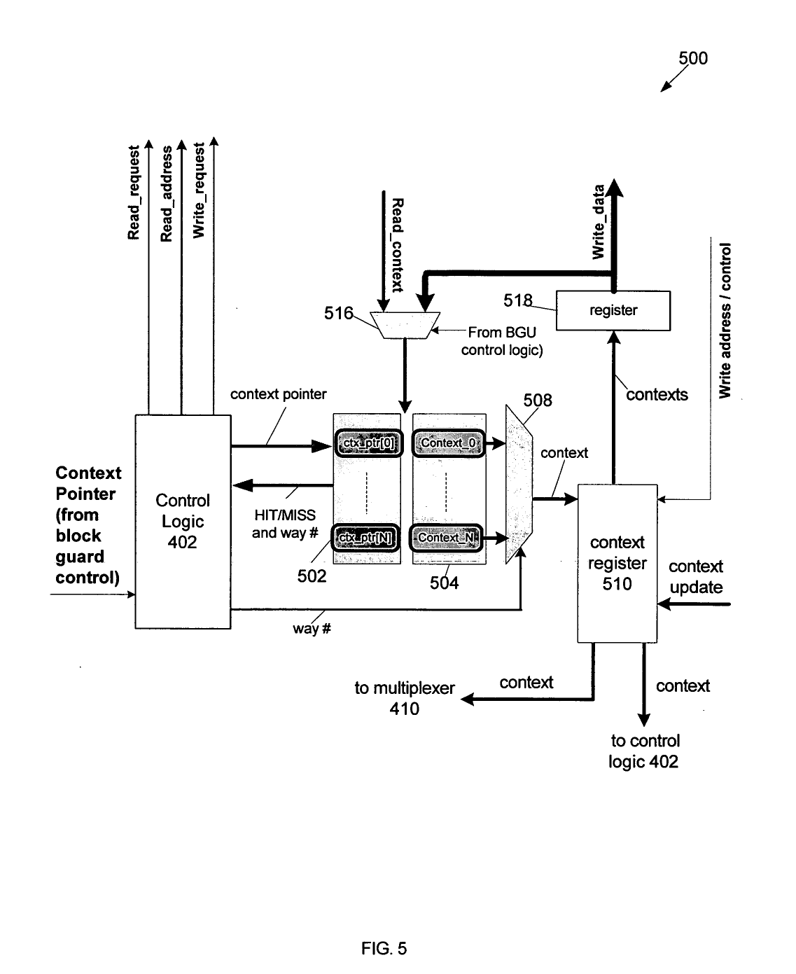

FIG. 5 depicts an example implementation of a context cache 500 in accordance with an embodiment of the present invention, although other implementations may be used. For example, context cache 500 may include context pointer register 502, context register 504, multiplexer 508, context register 510, multiplexer 516, and register 518.

Context pointer register 502 may store context pointers associated with contexts stored in context register 504. For example, multiplexer 516 may gate the storage of contexts into context register 504. For example, contexts to be stored into context register 504 may be provided by context memory or control logic 404 from BGU 400, although other sources of contexts may be used. For example, control logic 404 may control which context is written into context register 504.

Control logic 402 may transfer a context pointer received with a read/write request to context pointer register 502. Context pointer register 502 may determine whether the context associated with the provided context pointer is stored in context register 504. Context pointer register 502 may indicate whether the context is stored in context register 504 by providing a hit or miss indication.

If the context is stored in context register 504, a hit indication is provided and context pointer register 502 provides a “way” number of the context. Control logic 402 may use the way number to request multiplexer 508 to release the context associated with the way number to transfer the context from context register 504 into context register 510. Context register 510 may release the context (or fields of the context) to at least control logic 402, BG computer and comparator 408, and multiplexer 410.

If the context is not stored in context register 504, a miss indication is provided. For each context cache miss, control logic 402 may issue an instruction with fields Read_request and Read_address to the context memory to request the context associated with the missing context pointer (shown as the signal marked Read_context) to be transferred to multiplexer 516. Multiplexer 516 may transfer the context into context register 504 based on commands from control logic 402.

For example, if a context miss occurs and the context cache 500 is full, context cache 500 may evict a context from context register 504 by sending the evicted context to be written into context memory. For example, contexts may be evicted on a round-robin or least-used basis. For example, control logic 402 may issue a Write_request to the context memory to request to write an evicted context into context memory. In response, the context memory may provide signal labeled Write address/control to context register 510 to request the evicted context. The evicted context may be provided to register 518 which may provide the evicted context (shown as Write_data) to context memory. Contexts in context cache may be updated in context memory periodically or when the context is evicted from the context cache.

For example, when a new data I/O stream is to be processed, any context associated with the beginning of the new I/O stream may be replaced even if stored in the context cache 500. For example, a read/write request for the new data I/O stream may indicate the beginning of a new data I/O stream. Control logic 402 may request the context associated with the beginning of the new I/O stream to be stored (or replace the stored context in context cache 500, as the case may be) into context cache 500 by issuing an instruction with fields Read_request and Read_address to the context memory to request the context associated with the missing context pointer to be transferred to multiplexer 516 (shown as the signal marked Read_context). Multiplexer 516 may transfer the context into context register 504 based on commands from control logic 402.

If a context is modified by block guard unit 400, the modified context may be written back into context register 504 (shown as “context update”). For example, modified fields in a context that may include: INTERMEDIATE_CRC_SEED, REFERENCE_TAG_VERIFY, Rem_blk_bc, N_DIFF, error, and/or REFERENCE_TAG_GENERATE. Context updates may be provided to context register 510. The updated context may be transferred through update register 518 and multiplexer 516 for storage into context register 504.

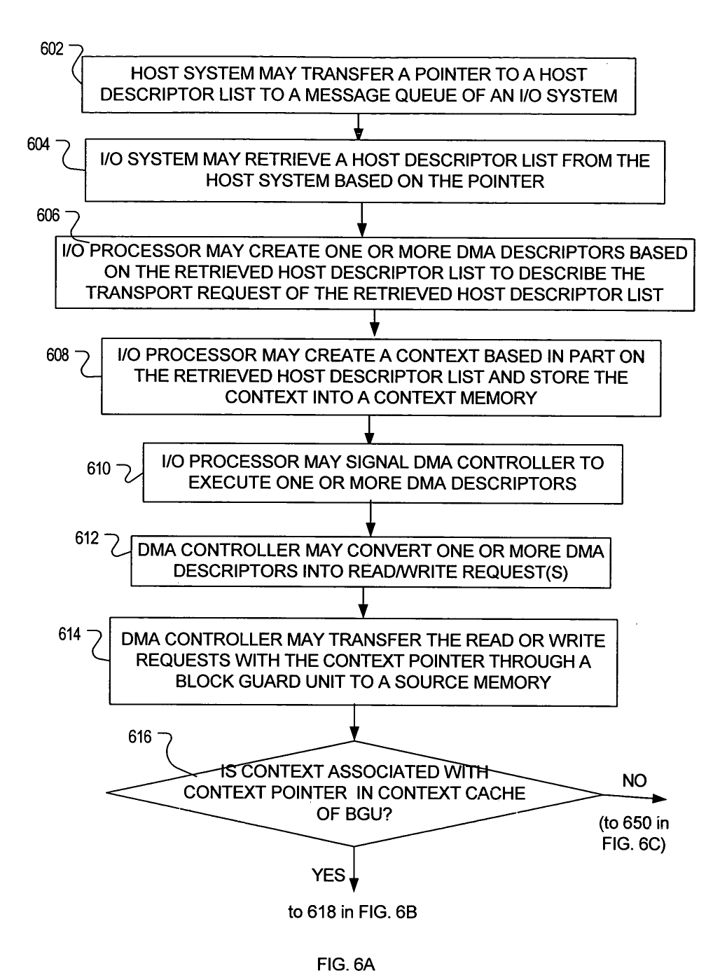

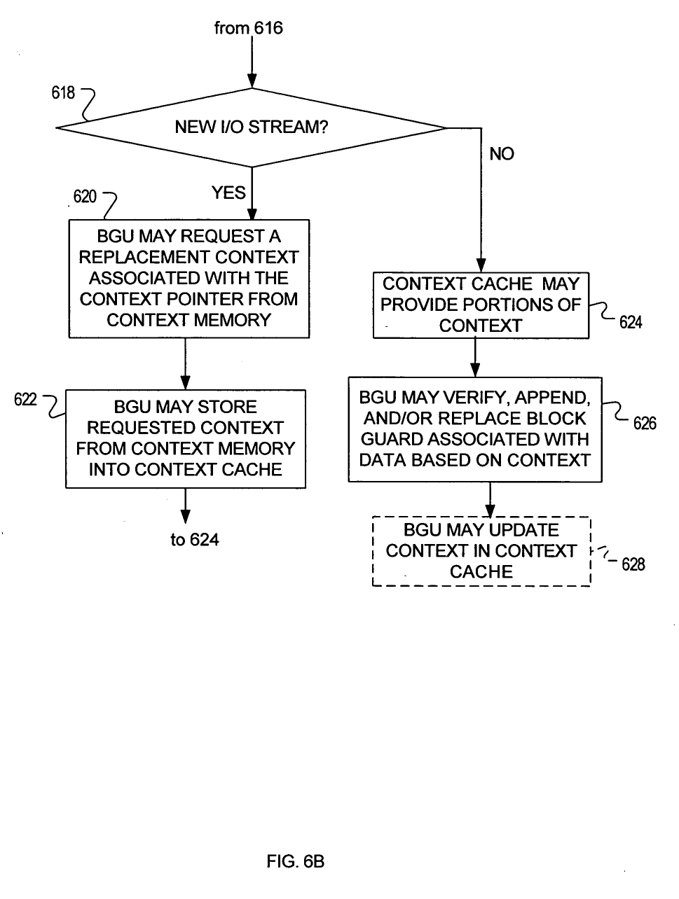

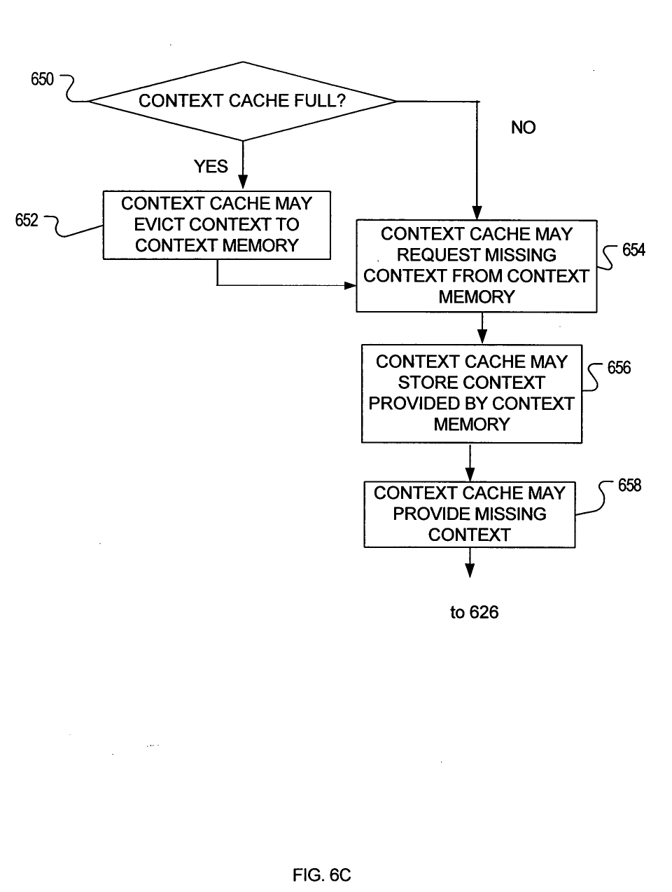

FIGS. 6A to 6C depict example flow diagrams that can be used in accordance with an embodiment of the present invention. In block 602, a host system may transfer to a message queue of an I/O system a pointer that refers to a host descriptor list. The I/O system may be used to transfer information between host and local memories. In one embodiment, the local memory may be used to temporarily store information intended to be stored in and transferred from system memory.

In block 604, the I/O processor of an I/O system may retrieve a host descriptor list from the host system based on a pointer in the message queue.

In block 606, the I/O processor may create one or more DMA descriptors based on the retrieved host descriptor list to describe the transport request of the retrieved host descriptor list.

In block 608, the I/O processor may create a context based in part on the retrieved host descriptor list and store the context into a context memory.

In block 610, the I/O processor may signal a DMA controller to execute one or more DMA descriptors.

In block 612, the DMA controller may convert a DMA descriptor into read or write requests with context pointer and beginning of I/O stream indicator.

In block 614, the DMA controller may transfer the read or write requests with the context pointer through a block guard unit to a source memory. The source memory may be one of the host memory, a storage of the DMA controller, or local memory whereas a destination memory to receive information transferred from the source memory may be one of the local memory, a storage of the DMA controller, or host memory.

In block 616, the block guard unit (BGU) determines whether context associated with the context pointer is stored in context cache of the BGU. If the context is stored in the context cache, then block 618 follows block 616. If the context is not stored in the context cache, then block 650 follows block 616. For example, the block guard unit may intercept the read or write requests with the context pointer and read the context pointer.

In block 618 (shown in FIG. 6B), the BGU determines whether the requested data is part of a new I/O stream. For example, the write or read request may also indicate whether the write or read request is associated with a new I/O stream. If the request is for a new I/O stream, then block 620 may follow block 618. If the data is not for a new I/O stream, then block 624 may follow block 618. In block 620, the BGU may request from context memory a replacement context for the context associated with the context pointer provided with the current write or read request. In block 622, the BGU may store the requested replacement context from context memory into context cache. Block 624 may follow block 622.

In block 624, the context cache may provide portions of the requested context. For example, the context may be that associated with the context pointer and stored in the context cache or the requested context replaced in block 622. In block 626, BGU may verify, append, and/or replace the block guard (BG) associated with the data based on the provided context. For example, the BGU may derive a block guard from the provided portions of the context. In optional block 628, if the context was modified, BGU may update the context in the context cache. For example, block 628 may be used if the block guard used in block 626 was modified.

In block 650 (shown in FIG. 6C), the BGU may determine whether the context cache is full. If the context cache is full, the block 652 may follow block 650. If the context cache is not full, the block 654 may follow block 650. In block 652, the context cache may evict a context to context memory. Block 654 may follow block 652. In block 654, the context cache may request the missing context associated with the context pointer provided in block 616 from context memory. In block 656, the context cache may store the context provided by context memory. In block 658, the context cache may provide the context stored in block 656. Block 626 may follow block 658.

### MODIFICATIONS

The drawings and the forgoing description gave examples of the present invention. While a demarcation between operations of elements in examples herein is provided, operations of one element may be performed by one or more other elements. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method comprising:
storing at least one context in a cache;
intercepting an access request transmitted to a source memory device;
intercepting data transferred by the source memory device in response to the access request;
selectively retrieving a context associated with the access request from a context cache based on availability of the context in the context cache;
forming a block guard based on the associated context;
selectively processing a block guard associated with the data based in part on the formed block guard; and
transferring the data to a destination memory device.

2. The method of claim 1, wherein the selectively retrieving a context associated with the access request from a context cache comprises:
determining whether the context is stored in the context cache; and
if the context is not stored in the context cache, requesting the context from a context memory;

3. The method of claim 1, wherein the selectively retrieving a context associated with the access request from a context cache comprises:
if the context is stored in the context cache and the access request is for a new I/O stream, requesting the context associated with the access request from a context memory.

4. The method of claim 1, wherein the selectively retrieving a context associated with the access request from a context cache comprises:
if the context is not stored in the context cache and the context cache is full, evicting a context from the context cache and requesting the context associated with the access request from a context memory.

5. The method of claim 1, wherein the selectively processing comprises:
verifying a cyclical redundancy check value in the block guard associated with the data based on the formed block guard.

6. The method of claim 1, wherein the selectively processing comprises:
verifying a cyclical redundancy check value in the block guard associated with the data based on the formed block guard; and
replacing the block guard associated with the formed block guard.

7. The method of claim 1, wherein the selectively processing comprises:
verifying a cyclical redundancy check value in the block guard associated with the data based on the formed block guard; and
appending the formed block guard to the data.

8. The method of claim 1, wherein the data includes at least a first and second portions and further comprising:
affixing the formed block guard to a first portion of the data; and
adjusting a destination address of the second portion of the data based on the size of the affixed block guard.

9. An apparatus comprising:
a block guard unit to intercept an access request transmitted to a source memory device and to intercept a data stream transferred by the source memory device in response to processing of the access request, wherein the block guard unit comprises:
a cache to store at least one context;
a control logic to determine whether a context associated with the access request is stored in the cache and to form a block guard based on the context provided by the cache;
a lane shifter to selectively shift the first valid byte of the data stream to a zero byte lane among data lanes;
a block guard computer to receive the data stream from the lane shifter and to selectively process a block guard associated with the data stream based in part on the formed block guard; and
a multiplexer to selectively transfer the data stream and the formed block guard.

10. The apparatus of claim 9, wherein for each data block in the data stream, the block guard computer computes a cyclical redundancy check value and compares the computed cyclical redundancy check value against the cyclical redundancy check value in the block guard associated with the data stream.

11. The apparatus of claim 9, wherein for each data block in the data stream, the block guard computer computes a cyclical redundancy check value and compares the computed cyclical redundancy check value against the cyclical redundancy check value in the block guard associated with the data stream and wherein the multiplexer replaces the block guard associated with the data stream with a block guard incorporating the computed cyclical redundancy check value.

12. The apparatus of claim 9, wherein for each data block in the data stream, the block guard computer computes a cyclical redundancy check value and compares the computed cyclical redundancy check value against the cyclical redundancy check value in the block guard associated with the data stream and wherein the multiplexer appends the computed cyclical redundancy check value in a block guard to the data stream.

13. The apparatus of claim 9, wherein the data stream includes first and second portions, wherein the multiplexer appends a block guard to the first portion, and wherein the control logic modifies a destination address of the second portion based on the size of the appended block guard.

14. The apparatus of claim 9, wherein if the cache stores the associated context, the cache provides the context.

15. The apparatus of claim 9, wherein if the cache does not store the associated context, the control logic requests a context memory to provide the context for storage into the cache and the cache provides the context.

16. The apparatus of claim 9, wherein if the cache does not store the associated context and the cache is full, the cache evicts a context and retrieves the associated context from context memory.

17. The apparatus of claim 9, wherein for a new data stream, the control logic requests a context memory to provide a replacement context for storage into the cache and the cache provides the replacement context as the associated context.

18. A system comprising:
a host system comprising a processor, a memory device, and an intercommunication device;
a local memory;
a storage device communicatively coupled to receive information from the local memory and provide information to the local memory;
an I/O system communicatively coupled to the intercommunication device and to provide information transfer between the local memory and the host system, wherein the I/O system includes:
an I/O processor to initiate and sending of access requests to transfer information; and
a block guard unit to intercept an access request transmitted to a source memory device and to intercept a data stream transferred by the source memory device in response to processing of the access request, wherein the block guard unit comprises:
a cache to store at least one context;
a control logic to determine whether a context associated with the access request is stored in the cache and to form a block guard based on the context provided by the cache;
a lane shifter to selectively shift the first valid byte of the data stream to a zero byte lane among data lanes;
a block guard computer to receive the data stream from the lane shifter and to selectively process a block guard associated with the data stream based in part on the formed block guard; and
a multiplexer to selectively transfer the data stream and the formed block guard.

19. The system of claim 18, further comprising a network interface communicatively coupled to the intercommunication device.

20. The system of claim 18, wherein the intercommunication device includes a PCI compatible bus.

21. The system of claim 18, wherein the intercommunication device includes a PCI express compatible bus.
